(19) United States
(12) Patent Application Publication
(10) Pub. No.: US 2022/0125556 A1
(43) Pub. Date: Apr. 28, 2022

(54) DENTAL IMPLANTS

(71) Applicant: TAV MEDICAL LTD., Shlomi (IL)

(72) Inventors: Meir BEN SHABAT, Shlomi (IL); Dan BEN SHABAT, Shlomi (IL); Oded BEN SHABAT, Shlomi (IL)

(73) Assignee: TAV MEDICAL LTD., Shlomi (IL)

(21) Appl. No.: 17/431,313

(22) PCT Filed: Mar. 4, 2020
(86) PCT No.: PCT/IL2020/050250

§ 371 Date: Aug. 16, 2021

Related U.S. Application Data
(60) Provisional application No. 62/814,974, filed on Mar. 7, 2019.

(51) Int. Cl. A61C 8/00

(52) U.S. Cl. CPC A61C 8/0012; A61C 8/0068

(57) ABSTRACT

A dental implant including a base body, anchorable in a jawbone, defining a bone line and having formed therein an axial hole having an internally threaded portion extending from a first location to a second location, the axial hole defining a first length L1 extending from the first location to the bone line, the base body having formed thereon an externally threaded portion and defining a bearing surface, an implant superstructure configured to be attached to the base body and to contact the bearing surface, and a screw configured for attaching the implant superstructure to the base body, whereby in an assembled state, the dental implant defines a distance L3, between a location at which the screw threadably engages the internally threaded portion and a location at which a shoulder of the screw engages a shoulder of the implant superstructure, which is substantially greater than the first length L1.

### REFERENCE TO RELATED APPLICATIONS

Reference is made to U.S. Provisional Patent Application Ser. No. 62/814,974 filed Mar. 7, 2019 and entitled: DENTAL IMPLANTS, the disclosure of which is hereby incorporated by reference and priority of which is claimed.

### FIELD OF THE INVENTION

The present invention relates to dental implants generally.

### BACKGROUND OF THE INVENTION

Various types of dental implants are known in the art.

### SUMMARY OF THE INVENTION

The present invention seeks to provide improved dental implants.

There is thus provided in accordance with a preferred embodiment of the present invention a dental implant including a base body, formed as a single ceramic piece or formed of a polymer or a composite material, the base body having an outer surface, anchorable in a jawbone, the base body defining a bone line, which is configured to be located adjacent a top of the jawbone, the base body having an apex, which is configured to be inserted within the jawbone, the base body having formed therein an axial hole extending from an opening of the axial hole to an end of the axial hole, the axial hole having an internally threaded portion located adjacent the end of the axial hole, the internally threaded portion extending from a first location in the axial hole, furthest from the end of the axial hole, to a second location in the axial hole, closest to the end, the axial hole defining a first length L1 extending from the first location to the bone line, the axial hole defining a first inner facing base body surface having a first inner diameter ID1 along at least part of the first length L1, the base body having formed thereon an externally threaded portion and the base body defining a bearing surface, an implant superstructure configured to be attached to the base body and to contact the bearing surface of the base body and including a shoulder and a screw configured for attaching the implant superstructure to the base body, the screw including a head portion and a shank portion, the shank portion including at least one smooth shank portion and a threaded portion, the screw defining a shoulder between the head portion and the shank portion, the at least one smooth shank portion being configured to have a first outer diameter OD1, which is substantially less than the first inner diameter ID1 of the axial hole, whereby in an assembled state of the dental implant, the at least one smooth shank portion is spaced from the first inner facing base body surface and the dental implant defines a distance L3, between a location furthest from the apex at which the threaded portion of the screw threadably engages the internally threaded portion of the axial hole and a location at which the shoulder of the screw engages the shoulder of the implant superstructure, which is substantially greater than the first length L1.

In accordance with a preferred embodiment of the present invention the base body is formed as a single ceramic piece.

In an alternative embodiment, the base body is formed of a polymer. Additionally, the polymer is polyether ether ketone (PEEK). Additionally or alternatively, the polymer is reinforced.

In another alternative embodiment, the base body is formed of a composite material.

In accordance with a preferred embodiment of the present invention the distance L3 is equal to or greater than 5.1 mm. More preferably, the distance L3 is equal to or greater than 5.3 mm. Even more preferably, the distance L3 is equal to or greater than 5.5 mm. Still more preferably, the distance L3 is equal to or greater than 6.0 mm. Most preferably, the distance L3 is equal to or greater than 6.9 mm.

Preferably, the dental implant is characterized by limited bendability of the screw, thereby reducing stress applied to mutually engaged threaded portions of the screw and the base body during use.

### BRIEF DESCRIPTION OF THE DRAWINGS

The present invention will be understood and appreciated more fully from the following description, taken in conjunction with the drawings in which:

FIGS. 1A, 1B, 1C, 1D, 1E and 1F are simplified respective first and second side view, exploded view, top and bottom view and sectional illustrations of a dental implant constructed and operative in accordance with a preferred embodiment of the present invention, FIG. 1F being taken along lines F-F in FIG. 1D;

FIGS. 2A, 2B, 2C, 2D, 2E and 2F are simplified respective first and second side view, perspective view, top and bottom view and sectional illustrations of a base body, forming part of the dental implant of FIGS. 1A-1F, FIG. 2F being taken along lines F-F in FIG. 2D;

FIGS. 3A, 3B, 3C, 3D, 3E and 3F are simplified respective first and second side view, perspective view, top and bottom view and sectional illustrations of a screw, forming part of the dental implant of FIGS. 1A-1F, FIG. 3F being taken along lines F-F in FIG. 3D;

FIGS. 4A, 4B, 4C, 4D, 4E and 4F are simplified respective first and second side view, perspective view, top and bottom view and sectional illustrations of an abutment, forming part of the dental implant of FIGS. 1A-1F, FIG. 4F being taken along lines F-F in FIG. 4D;

FIGS. 5A, 5B, 5C, 5D, 5E and 5F are simplified respective first and second side view, exploded view, top and bottom view and sectional illustrations of a dental implant constructed and operative in accordance with another preferred embodiment of the present invention, FIG. 5F being taken along lines F-F in FIG. 5D;

FIGS. 5G, 5H, 5I, 5J, 5K and 5L are simplified respective first and second side view, perspective view, top and bottom view and sectional illustrations of a base body, forming part of the dental implant of FIGS. 5A-5F, FIG. 5L being taken along lines L-L in FIG. 5J;

FIGS. 6A, 6B, 6C, 6D, 6E and 6F are simplified respective first and second side view, perspective view, top and bottom view and sectional illustrations of a screw, forming part of the dental implant of FIGS. 5A-5F, FIG. 6F being taken along lines F-F in FIG. 6D;

FIGS. 7A, 7B, 7C, 7D, 7E and 7F are simplified respective first and second side view, exploded view, top and bottom view and sectional illustrations of a dental implant constructed and operative in accordance with yet another preferred embodiment of the present invention, FIG. 7F being taken along lines F-F in FIG. 7D;

FIGS. 7G, 7H, 7I, 7J, 7K and 7L are simplified respective first and second side view, perspective view, top and bottom view and sectional illustrations of a base body, forming part of the dental implant of FIGS. 7A-7F, FIG. 7L being taken along lines L-L in FIG. 7J;

FIGS. 8A, 8B, 8C, 8D, 8E and 8F are simplified respective first and second side view, perspective view, top and bottom view and sectional illustrations of a screw, forming part of the dental implant of FIGS. 7A-7F, FIG. 8F being taken along lines F-F in FIG. 8D;

FIGS. 9A, 9B, 9C, 9D, 9E and 9F are simplified respective first and second side view, exploded view, top and bottom view and sectional illustrations of a dental implant constructed and operative in accordance with still another preferred embodiment of the present invention, FIG. 9F being taken along lines F-F in FIG. 9D;

FIGS. 9G, 9H, 9I, 9J, 9K and 9L are simplified respective first and second side view, perspective view, top and bottom view and sectional illustrations of a base body, forming part of the dental implant of FIGS. 9A-9F, FIG. 9L being taken along lines L-L in FIG. 9J;

FIGS. 10A, 10B, 10C, 10D, 10E and 10F are simplified respective first and second side view, perspective view, top and bottom view and sectional illustrations of a screw, forming part of the dental implant of FIGS. 9A-9F, FIG. 10F being taken along lines F-F in FIG. 10D;

FIGS. 11A, 11B, 11C, 11D, 11E and 11F are simplified respective first and second side view, perspective view, top and bottom view and sectional illustrations of an abutment, forming part of the dental implant of FIGS. 9A-9F, FIG. 11F being taken along lines F-F in FIG. 11D;

FIGS. 12A, 12B, 12C, 12D, 12E and 12F are simplified respective first and second side view, exploded view, top and bottom view and sectional illustrations of a dental implant constructed and operative in accordance with a further preferred embodiment of the present invention, FIG. 12F being taken along lines F-F in FIG. 12D;

FIGS. 13A, 13B, 13C, 13D, 13E and 13F are simplified respective first and second side view, perspective view, top and bottom view and sectional illustrations of a base body, forming part of the dental implant of FIGS. 12A-12F, FIG. 13F being taken along lines F-F in FIG. 13D;

FIGS. 14A, 14B, 14C, 14D, 14E and 14F are simplified respective first and second side view, perspective view, top and bottom view and sectional illustrations of a screw, forming part of the dental implant of FIGS. 12A-12F, FIG. 14F being taken along lines F-F in FIG. 14D; and

FIGS. 15A, 15B, 15C, 15D, 15E and 15F are simplified respective first and second side view, perspective view, top and bottom view and sectional illustrations of an abutment, forming part of the dental implant of FIGS. 12A-12F, FIG. 15F being taken along lines F-F in FIG. 15D.

### DETAILED DESCRIPTION OF PREFERRED EMBODIMENTS

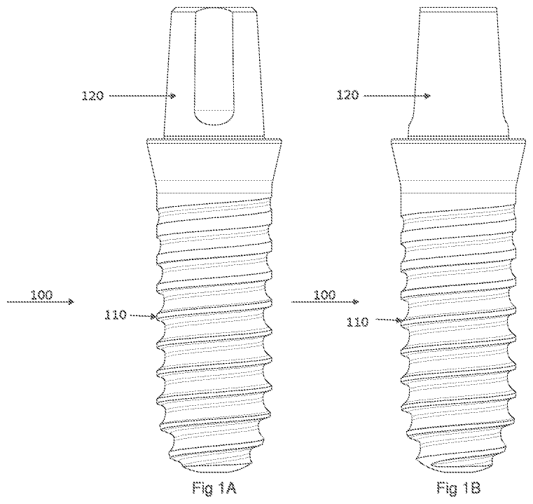

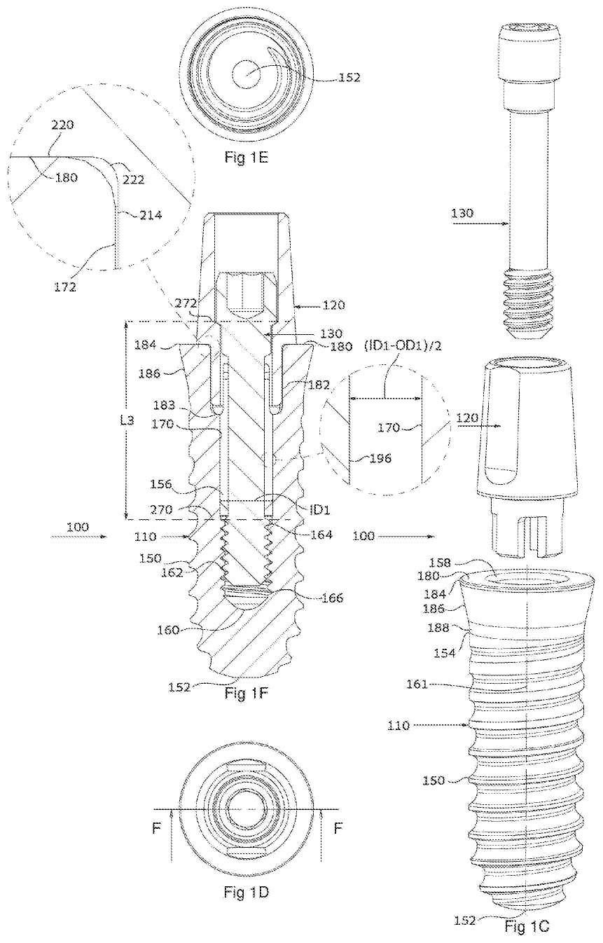

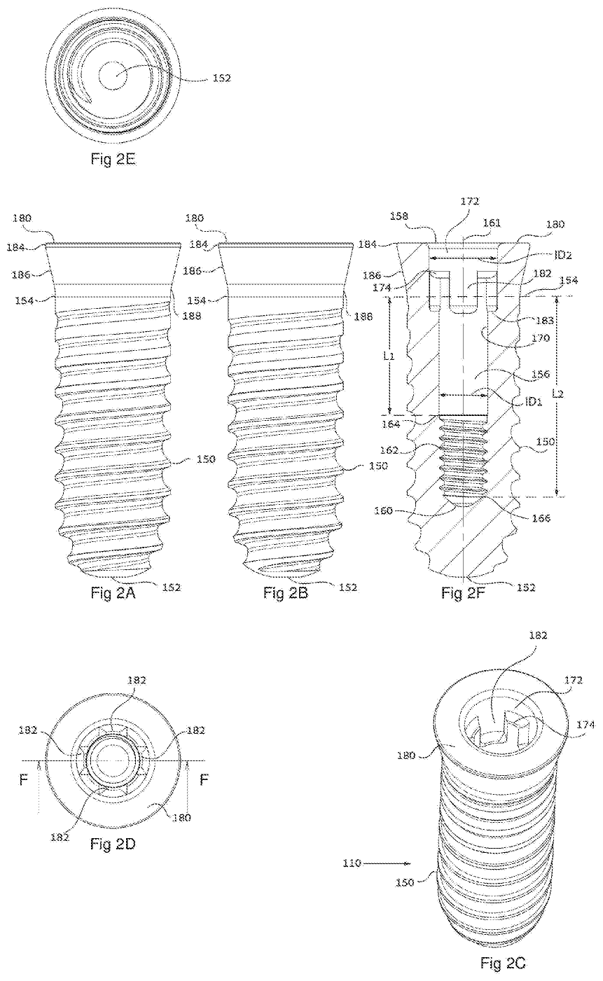

Reference is now made to FIGS. 1A, 1B, 1C, 1D, 1E and 1F, which are simplified illustrations of a dental implant constructed and operative in accordance with a preferred embodiment of the present invention, and to FIGS. 2A, 2B, 2C, 2D, 2E and 2F, which are simplified illustrations of a base body, forming part of the dental implant of FIGS. 1A-1F.

As seen in FIGS. 1A-1F, there is provided a dental implant 100 constructed and operative in accordance with a preferred embodiment of the present invention. The dental implant 100 preferably comprises a base body 110, preferably formed of a ceramic material, such as zirconia, or alternatively formed of a polymer, such as polyether ether ketone (PEEK), which may be reinforced, or as a further alternative formed of a composite material, and an implant superstructure, here an abutment 120, preferably formed of metal, such as titanium, or alternatively a ceramic or a polymer. The abutment 120 is secured to the base body 110 by a screw 130, preferably formed of metal, typically titanium, or alternatively a ceramic or a polymer.

In accordance with a preferred embodiment of the invention, and as shown in FIGS. 2A-2F, base body 110 is formed as a single ceramic piece having an outer surface and is anchorable in a jawbone. The outer surface of base body 110 is preferably formed with an externally threaded portion 150 extending from an apex 152 of the base body 110 nearly up to a bone line 154, which is the line at which the base body 110 is intended to protrude from the jawbone.

In accordance with a preferred embodiment of the present invention, base body 110 is formed with an axial hole 156 extending from an opening 158 of the axial hole 156 to a closed end 160 of the axial hole 156 about an axis 161, which is also the axis of symmetry of base body 110. The axial hole 156 is formed with an internally threaded portion 162, located adjacent end 160. The internally threaded portion 162 preferably extends from a first location 164 in the axial hole 156 furthest from the end 160 to a second location 166 in the axial hole 156 closest to the end 160.

A first length L1 is defined as the axially extending length of axial hole 156 from the first location 164 to the bone line 154. A second length L2 is defined as the axially extending length of axial hole 156 from the second location 166 to the bone line 154.

Axial hole 156 defines a first inner facing base body surface 170, having a first inner diameter ID1, along at least part of the first length L1, and a second inner facing base body surface 172, having a second inner diameter ID2 and extending upwardly from the first inner facing base body surface 170 and defining therewith a shoulder 174.

Base body 110 defines a bearing surface 180, which is preferably a flat annular surface which surrounds opening 158 of axial hole 156, at second inner facing base body surface 172, having second inner diameter ID2. Formed in first inner facing base body surface 170 of base body 110 are typically four evenly azimuthally distributed axially directed recesses 182, which are radially spaced from and extend parallel to axis 161 and removably accommodate an installation tool (not shown) and abutment 120. Recesses 182 extend downwardly to a location 183 typically just below the bone line 154.

As seen particularly in the illustrated embodiment of FIG. 2F, axial hole 156 is preferably formed with a generally circular cross section along first length L1 and first inner diameter ID1 is a diameter thereof. Alternatively, axial hole 156 may be formed with any suitable cross sectional configuration, such as rectangular or hexagonal, and first inner diameter ID1 is defined as the diameter of the largest circle circumscribed thereby. In another alternative embodiment, internally threaded portion 162 of axial hole 156 may extend upwardly to location 183 and first inner diameter ID1 is defined as the inner diameter of internally threaded portion 162 of axial hole 156.

Preferably, the outer surface of base body 110 includes a curved top portion 184 adjacent bearing surface 180. Below curved top portion 184 is a main inwardly downwardly tapered portion 186, which terminates in an intermediate portion 188, which preferably is a circular cylindrical portion, which terminates at the bone line 154.

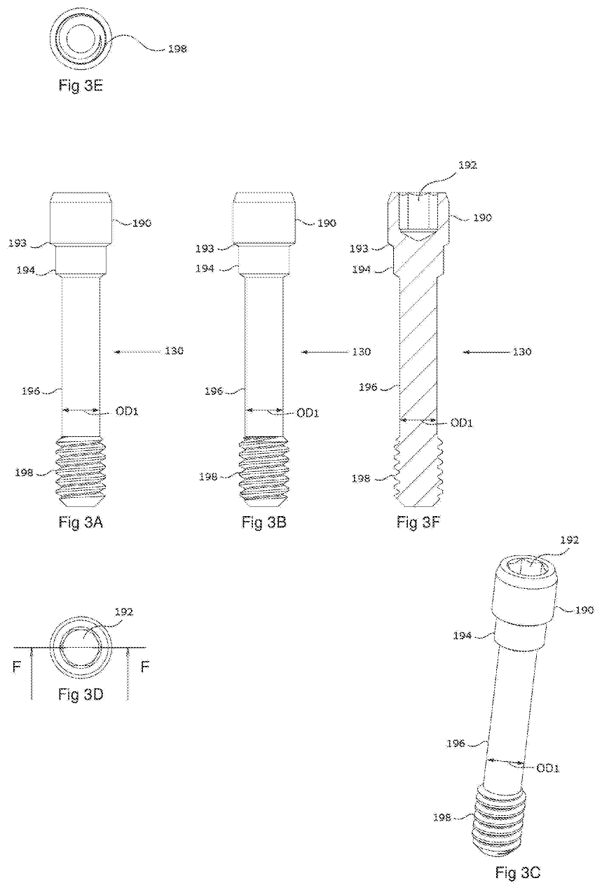

Reference is now made to FIGS. 3A, 3B, 3C, 3D, 3E and 3F, which are simplified respective first and second side view, perspective view, top and bottom view and sectional illustrations of a preferred embodiment of screw 130, forming part of the dental implant of FIGS. 1A-1F, FIG. 3F being taken along lines F-F in FIG. 3D.

As seen in FIGS. 3A-3F, screw 130 is an elongate, generally circularly symmetric element configured to threadably engage axial hole 156 in base body 110. Screw 130 comprises a head portion 190 having an internal socket 192. Extending below head portion 190 and defining a shoulder 193 therewith, is an intermediate portion 194 and below intermediate portion 194 is at least one shank portion, preferably a single smooth shank portion 196, which terminates in a threaded portion 198. The smooth shank portion 196 has a first outer diameter OD1, which is configured to be substantially less than the first inner diameter ID1 of axial hole 156. Typically OD1 is 1.35 mm and ID1 is 1.95 mm.

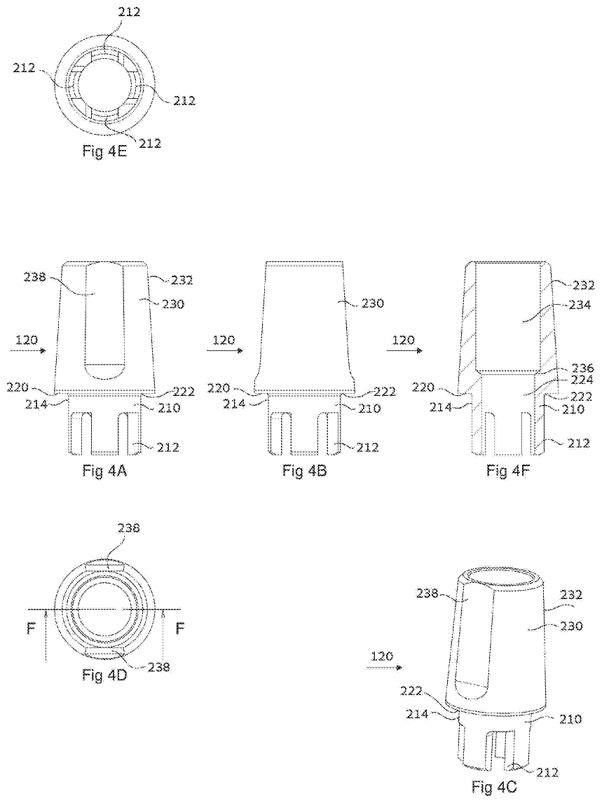

Reference is now made to FIGS. 4A, 4B, 4C, 4D, 4E and 4F, which are simplified respective first and second side view, perspective view, top and bottom view and sectional illustrations of abutment 120, forming part of the dental implant of FIGS. 1A-1F, FIG. 4F being taken along lines F-F in FIG. 4D. Abutment 120 forms all or part of an implant superstructure.

As seen in FIGS. 4A-4F, abutment 120 comprises a generally cylindrical base portion 210 having typically four evenly azimuthally distributed axially directed teeth 212 configured to securely seat in corresponding evenly azimuthally distributed axially directed recesses 182 of base body 110. Generally cylindrical base portion 210 is preferably formed with a generally cylindrical outer surface 214, which terminates upwardly at an annular downward-facing engagement surface 220 at a curved circular junction 222. Generally cylindrical base portion 210 is preferably formed with a cylindrical axial bore 224.

Extending upwardly from engagement surface 220 is a hollow, generally conical portion 230, having a conical outer surface 232 and a cylindrical axial bore 234, which defines a shoulder 236 with cylindrical axial bore 224. Conical outer surface 232 is preferably formed with a pair of oppositely-facing elongate recesses 238.

Returning now to FIGS. 1A, 1B, 1C, 1D, 1E and 1F, it is seen that when the dental implant 100 is an assembled state, following anchoring of the base body 110 in a jawbone, threaded portion of screw 130 is fully threaded into corresponding threaded portion 162 of base body 110.

It is a particular feature of the illustrated embodiment of the present invention that, as seen particularly in the enlargement of FIG. 1F, generally cylindrical outer surface 214 of abutment 120 is spaced from second inner facing base body surface 172 of base body 110 adjacent curved circular junction 222, typically by a radial separation of 0.01 mm, while engagement surface 220 is in tight engagement with bearing surface 180.

It is a further particular feature of the illustrated embodiment of the present invention, that, as seen particularly in FIG. 1F, the smooth shank portion 196 of screw 130, which extends along the length of axial hole 156, is spaced from the inner-facing base body surface 170 of the base body 110, preferably by an radial separation, (ID1−OD1)/2, of approximately 0.3 mm.

It is a further particular feature of the illustrated embodiment of the present invention, as seen particularly in FIG. 1F, that an axial distance, which is a relatively large axial distance compared to existing non-metal dental implants, defined as L3, from a highest location 270 of mutually engaged threadings of the screw 130 and the base body 110 to a location 272 at which shoulder 193 of screw 130 engages shoulder 236 of abutment 120, is defined in the assembled implant.

It is appreciated that the present invention is characterized by limited bendability of screw 130, thereby reducing stress applied to mutually engaged threaded portions of screw 130 and base body 110 during use.

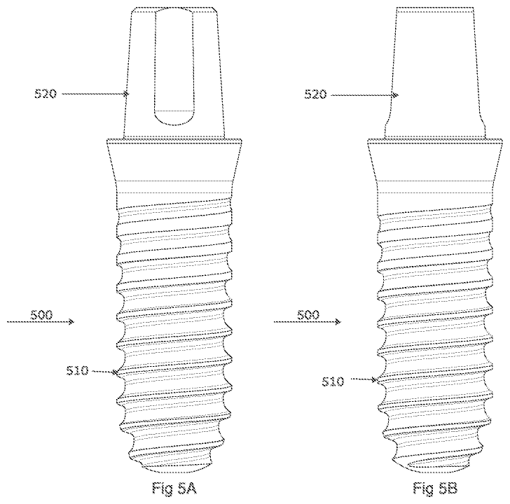

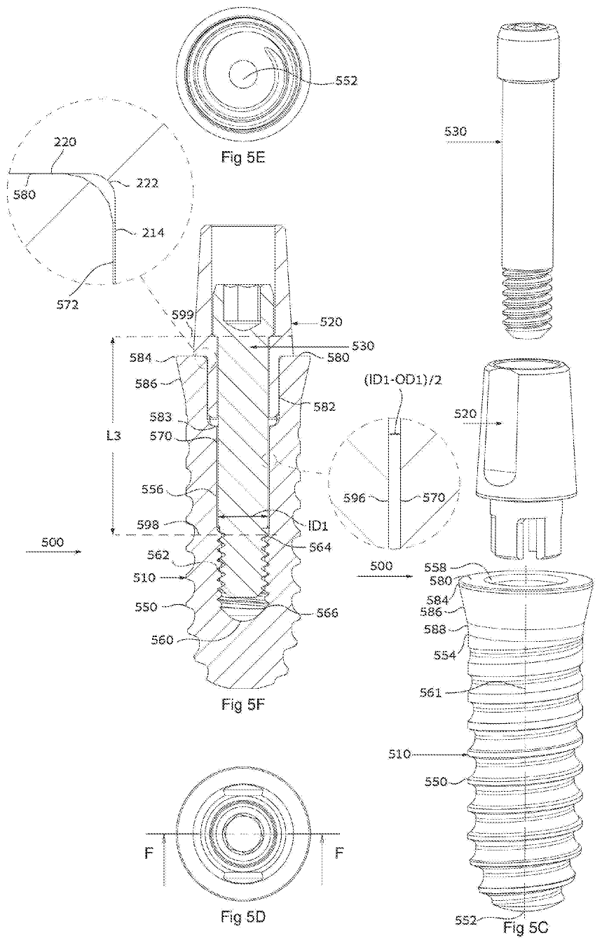

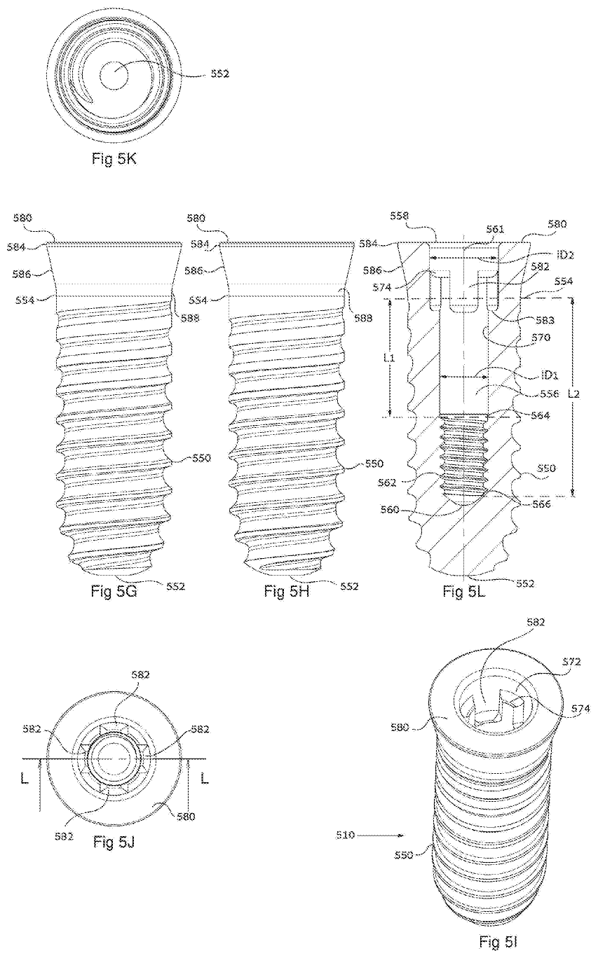

Reference is now made to FIGS. 5A, 5B, 5C, 5D, 5E and 5F, which are simplified illustrations of a dental implant constructed and operative in accordance with another preferred embodiment of the present invention, and to FIGS. 5G, 5H, 5I, 5J, 5K and 5L, which are simplified illustrations of a base body, forming part of the dental implant of FIGS. 5A-5F.

As seen in FIGS. 5A-5F, there is provided a dental implant 500 constructed and operative in accordance with a preferred embodiment of the present invention. The dental implant 500 preferably comprises a base body 510, preferably formed of a ceramic material, such as zirconia, or alternatively formed of a polymer, such as polyether ether ketone (PEEK), which may be reinforced, or as a further alternative formed of a composite material, and an implant superstructure, here an abutment 520, preferably formed of metal, such as titanium, or alternatively a ceramic or a polymer. The abutment 520 is secured to the base body 510 by a screw 530, preferably formed of metal, typically titanium, or alternatively a ceramic or a polymer.

In accordance with a preferred embodiment of the invention, and as shown in FIGS. 5G-5L, base body 510 is formed as a single ceramic piece having an outer surface and is anchorable in a jawbone. The outer surface of base body 510 is preferably formed with an externally threaded portion 550 extending from an apex 552 of the base body 510 nearly up to a bone line 554, which is the line at which the base body 510 is intended to protrude from the jawbone.

In accordance with a preferred embodiment of the present invention, base body 510 is formed with an axial hole 556 extending from an opening 558 of the axial hole 556 to a closed end 560 of the axial hole 556 about an axis 561, which is also the axis of symmetry of base body 510. The axial hole 556 is formed with internally threaded portion 562, located adjacent end 560. The internally threaded portion 562 preferably extends from a first location 564 in the axial hole 556 furthest from the end 560 to a second location 566 in the axial hole 556 closest to the end 560.

A first length L1 is defined as the axially extending length of axial hole 556 from the first location 564 to the bone line 554. A second length L2 is defined as the axially extending length of axial hole 556 from the second location 566 to the bone line 554.

Axial hole 556 defines a first inner facing base body surface 570, having a first inner diameter ID1, along at least part of the first length L1, and a second inner facing base body surface 572, having a second inner diameter ID2 and extending upwardly from the first inner facing base body surface 570 and defining therewith a shoulder 574.

Base body 510 defines a bearing surface 580, which is preferably a flat annular surface which surrounds opening 558 of axial hole 556, at second inner facing base body surface 572 having second inner diameter ID2. Formed in first inner facing base body surface 570 of base body 510 are typically four evenly azimuthally distributed axially directed recesses 582, which are radially spaced from and extend parallel to axis 561 and removably accommodate an installation tool (not shown) and abutment 520. Recesses 582 extend downwardly to a location 583 typically just below the bone line 554.

As seen particularly in the illustrated embodiment of FIG. 5L, axial hole 556 is preferably formed with a generally circular cross section along first length L1 and first inner diameter ID1 is a diameter thereof. Alternatively, axial hole 556 may be formed with any suitable cross sectional configuration, such as rectangular or hexagonal, and first inner diameter ID1 is defined as the diameter of the largest circle circumscribed thereby. In another alternative embodiment, internally threaded portion 562 of axial hole 556 may extend upwardly to location 583 and first inner diameter ID1 is defined as the inner diameter of internally threaded portion 562 of axial hole 556.

Preferably, the outer surface of base body 510 includes a curved top portion 584 adjacent bearing surface 580. Below curved top portion 584 is a main inwardly downwardly tapered portion 586, which terminates in an intermediate portion 588, which preferably is a circular cylindrical portion, which terminates at the bone line 554.

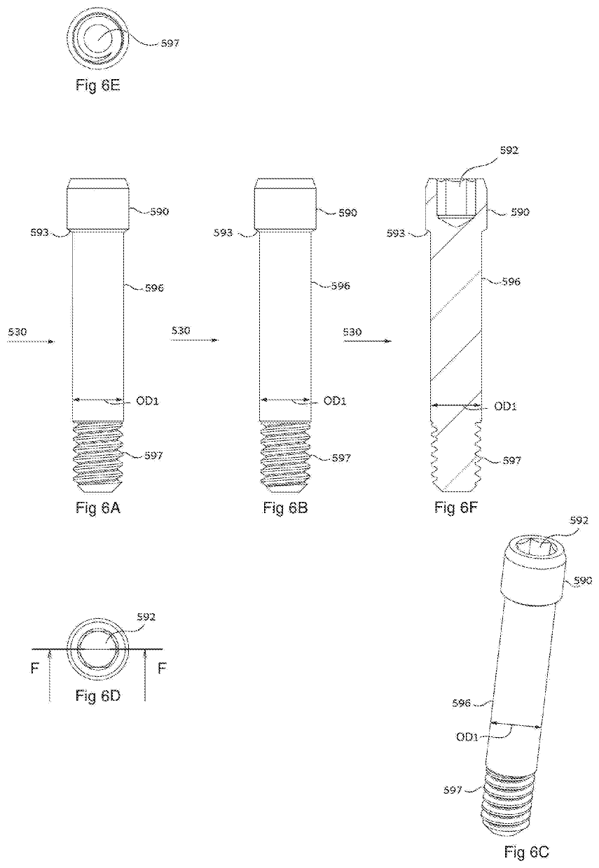

Reference is now made to FIGS. 6A, 6B, 6C, 6D, 6E and 6F, which are simplified respective first and second side view, perspective view, top and bottom view and sectional illustrations of a preferred embodiment of screw 530, forming part of the dental implant of FIGS. 5A-5F, FIG. 6F being taken along lines F-F in FIG. 6D.

As seen in FIGS. 6A-6F, screw 530 is an elongate, generally circularly symmetric element configured to threadably engage axial hole 556 in base body 510. Screw 530 comprises a head portion 590 having an internal socket 592. Extending below head portion 590 and defining a shoulder 593 therewith is at least one shank portion, preferably a single smooth shank portion 596, which terminates in a threaded portion 597. The smooth shank portion 596 has a first outer diameter OD1, which is configured to be substantially less than the first inner diameter ID1 of axial hole 556. Typically OD1 is 1.85 mm and ID1 is 1.95 mm.

Abutment 520 of dental implant 500 is preferably identical to abutment 120 of dental implant 100 described hereinabove with reference to FIGS. 4A-4F.

Returning now to FIGS. 5A, 5B, 5C, 5D, 5E and 5F, it is seen that when the dental implant 500 is an assembled state, following anchoring of the base body 510 in a jawbone, threaded portion of screw 530 is fully threaded into corresponding threaded portion 562 of base body 510.

It is a particular feature of the illustrated embodiment of the present invention that, as seen particularly in the enlargement of FIG. 5F, generally cylindrical outer surface 214 of abutment 520 is spaced from second inner facing base body surface 572 of base body 510 adjacent curved circular junction 222, typically by a radial separation of 0.01 mm, while engagement surface 220 is in tight engagement with bearing surface 580.

It is a further particular feature of the illustrated embodiment of the present invention, that, as seen particularly in FIG. 5F, the smooth shank portion 596 of screw 530, which extends along the length of axial hole 556, is spaced from the inner-facing base body surface 570 of the base body 510, preferably by an radial separation, (ID1−OD1)/2, of approximately 0.05 mm.

It is a further particular feature of the illustrated embodiment of the present invention, as seen particularly in FIG. 5F, that an axial distance, which is a relatively large axial distance compared to existing non-metal dental implants, defined as L3, from a highest location 598 of mutually engaged threadings of the screw 530 and the base body 510 and a location 599 at which shoulder 593 of screw 530 engages shoulder 236 of abutment 520, is defined in the assembled implant.

It is appreciated that the present invention is characterized by limited bendability of screw 530, thereby reducing stress applied to mutually engaged threaded portions of screw 530 and base body 510 during use.

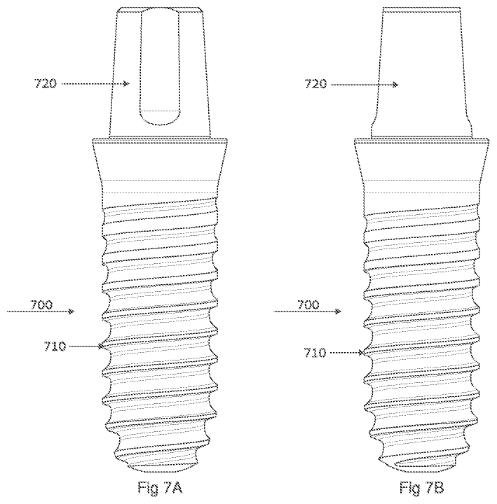

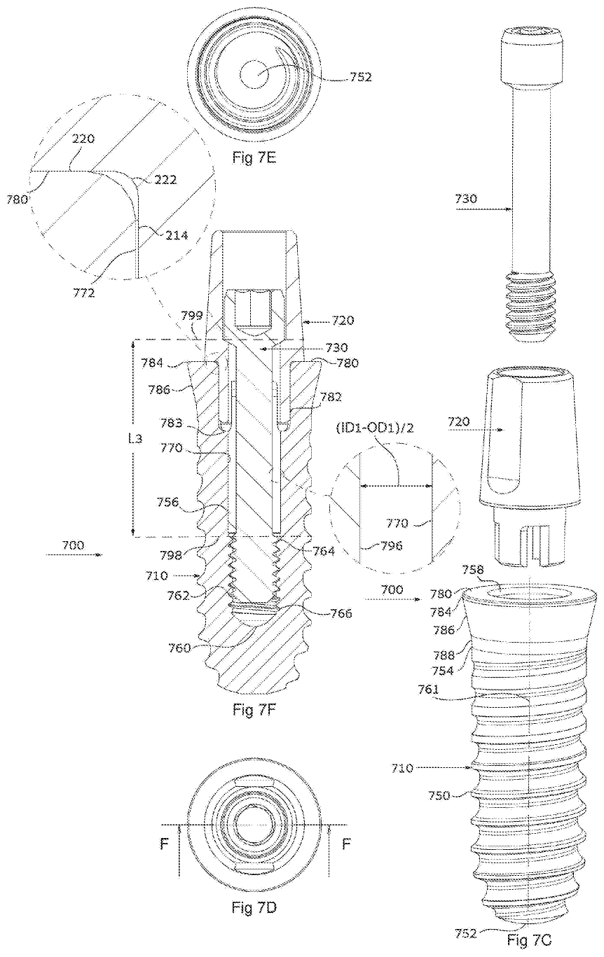

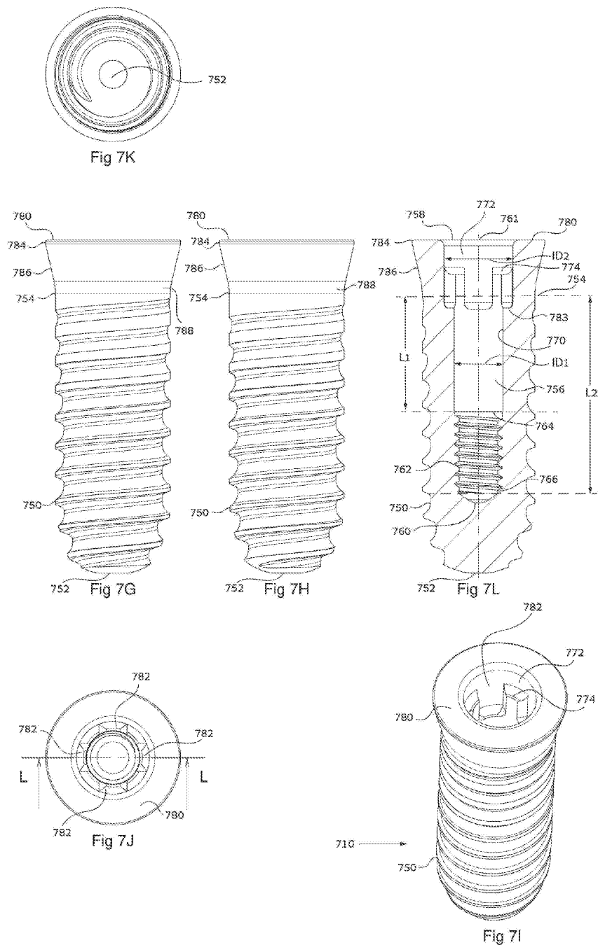

Reference is now made to FIGS. 7A, 7B, 7C, 7D, 7E and 7F, which are simplified illustrations of a dental implant constructed and operative in accordance with yet another preferred embodiment of the present invention, and to FIGS. 7G, 7H, 7I, 7J, 7K and 7L, which are simplified illustrations of a base body, forming part of the dental implant of FIGS. 7A-7F.

As seen in FIGS. 7A-7F, there is provided a dental implant 700 constructed and operative in accordance with a preferred embodiment of the present invention. The dental implant 700 preferably comprises a base body 710, preferably formed of a ceramic material, such as zirconia, or alternatively formed of a polymer, such as polyether ether ketone (PEEK), which may be reinforced, or as a further alternative formed of a composite material, and an implant superstructure, here an abutment 720, preferably formed of metal, such as titanium, or alternatively a ceramic or a polymer. The abutment 720 is secured to the base body 710 by a screw 730, preferably formed of metal, typically titanium, or alternatively a ceramic or a polymer.

In accordance with a preferred embodiment of the invention, and as shown in FIGS. 7G-7L, base body 710 is formed as a single ceramic piece having an outer surface and is anchorable in a jawbone. The outer surface of base body 710 is preferably formed with an externally threaded portion 750 extending from an apex 752 of the base body 710 nearly up to a bone line 754, which is the line at which the base body 710 is intended to protrude from the jawbone.

In accordance with a preferred embodiment of the present invention, base body 710 is formed with an axial hole 756 extending from an opening 758 of the axial hole 756 to a closed end 760 of the axial hole 756 about an axis 761, which is also the axis of symmetry of base body 710. The axial hole 756 is formed with internally threaded portion 762, located adjacent end 760. The internally threaded portion 762 preferably extends from a first location 764 in the axial hole 756 furthest from the end 760 to a second location 766 in the axial hole 756 closest to the end 760.

A first length L1 is defined as the axially extending length of axial hole 756 from the first location 764 to the bone line 754. A second length L2 is defined as the axially extending length of axial hole 756 from the second location 766 to the bone line 754.

Axial hole 756 defines a first inner facing base body surface 770, having a first inner diameter ID1, along at least part of the first length L1, and a second inner facing base body surface 772, having a second inner diameter ID2 and extending upwardly from the first inner facing base body surface 770 and defining therewith a shoulder 774.

Base body 710 defines a bearing surface 780, which is preferably a flat annular surface which surrounds opening 758 of axial hole 756, at second inner facing base body surface 772 having second inner diameter ID2. Formed in first inner facing base body surface 770 of base body 710 are typically four evenly azimuthally distributed axially directed recesses 782, which are radially spaced from and extend parallel to axis 761 and removably accommodate an installation tool (not shown) and abutment 720. Recesses 782 extend downwardly to a location 783 typically just below the bone line 754.

As seen particularly in the illustrated embodiment of FIG. 7L, axial hole 756 is preferably formed with a generally circular cross section along first length L1 and first inner diameter ID1 is a diameter thereof. Alternatively, axial hole 756 may be formed with any suitable cross sectional configuration, such as rectangular or hexagonal, and first inner diameter ID1 is defined as the diameter of the largest circle circumscribed thereby. In another alternative embodiment, internally threaded portion 762 of axial hole 756 may extend upwardly to location 783 and first inner diameter ID1 is defined as the inner diameter of internally threaded portion 762 of axial hole 756.

Preferably, the outer surface of base body 710 includes a curved top portion 784 adjacent bearing surface 780. Below curved top portion 784 is a main inwardly downwardly tapered portion 786, which terminates in an intermediate portion 788, which preferably is a circular cylindrical portion, which terminates at the bone line 754.

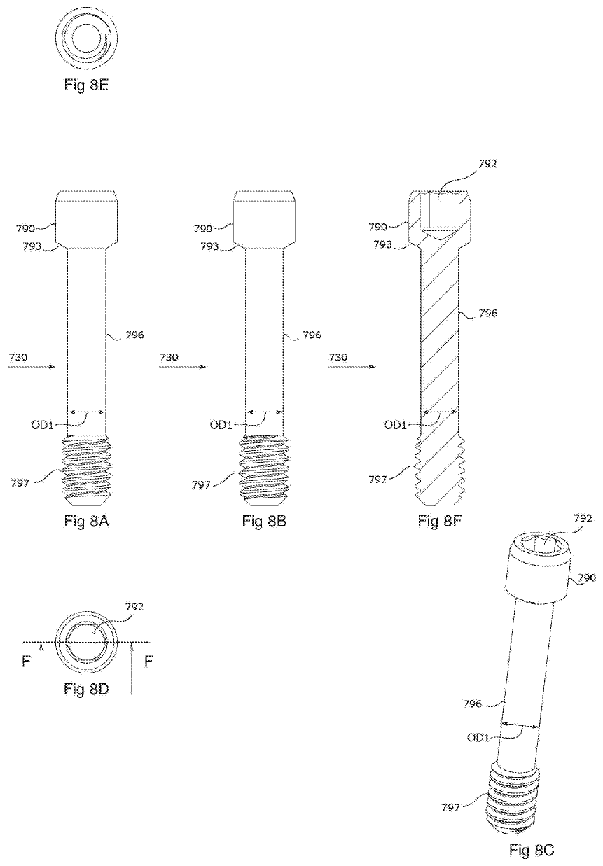

Reference is now made to FIGS. 8A, 8B, 8C, 8D, 8E and 8F, which are simplified respective first and second side view, perspective view, top and bottom view and sectional illustrations of a preferred embodiment of screw 730, forming part of the dental implant of FIGS. 7A-7F, FIG. 8F being taken along lines F-F in FIG. 8D.

As seen in FIGS. 8A-8F, screw 730 is an elongate, generally circularly symmetric element configured to threadably engage axial hole 756 in base body 710. Screw 730 comprises a head portion 790 having an internal socket 792. Extending below head portion 790 and defining a shoulder 793 therewith, is at least one shank portion, preferably a single smooth shank portion 796, which terminates in a threaded portion 797. The smooth shank portion 796 has a first outer diameter OD1, which is configured to be substantially less than the first inner diameter ID1 of axial hole 756. Typically OD1 is 1.35 mm and ID1 is 1.95 mm.

Abutment 720 of dental implant 700 is preferably identical to abutment 520 of dental implant 500 and to abutment 120 of dental implant 100 described hereinabove with reference to FIGS. 4A-4F.

Returning now to FIGS. 7A, 7B, 7C, 7D, 7E and 7F, it is seen that when the dental implant 700 is an assembled state, following anchoring of the base body 710 in a jawbone, the threaded portion of screw 730 is fully threaded into corresponding threaded portion 762 of base body 710.

It is a particular feature of the illustrated embodiment of the present invention that, as seen particularly in the enlargement of FIG. 7F, generally cylindrical outer surface 214 of abutment 720 is spaced from inner facing base body surface 772 of base body 710 adjacent curved circular junction 222, typically by a radial separation of 0.01 mm, while engagement surface 220 is in tight engagement with bearing surface 780.

It is a further particular feature of the illustrated embodiment of the present invention, that, as seen particularly in FIG. 7F, the smooth shank portion 796 of screw 730, which extends along the length of axial hole 756, is spaced from the inner-facing base body surface 770 of the base body 710, preferably by an radial separation, (ID1−OD1)/2, of approximately 0.3 mm.

It is a further particular feature of the illustrated embodiment of the present invention, as seen particularly in FIG. 7F, that an axial distance, which is a relatively large axial distance compared to existing non-metal dental implants, defined as L3, from a highest location 798 of mutually engaged threadings of the screw 730 and the base body 710 and a location 799 at which shoulder 793 of screw 730 engages shoulder 236 of abutment 720, is defined in the assembled implant.

It is appreciated that the present invention is characterized by limited bendability of screw 730, thereby reducing stress applied to mutually engaged threaded portions of screw 730 and base body 710 during use.

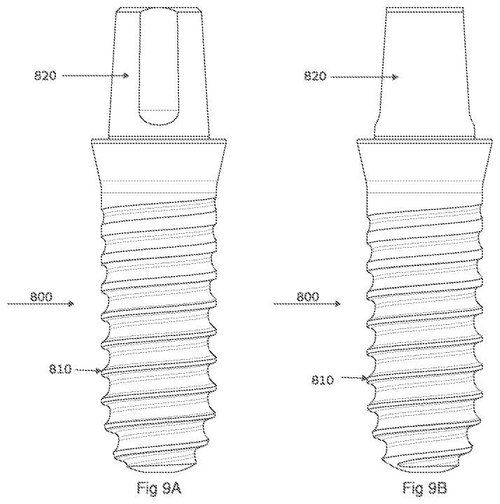

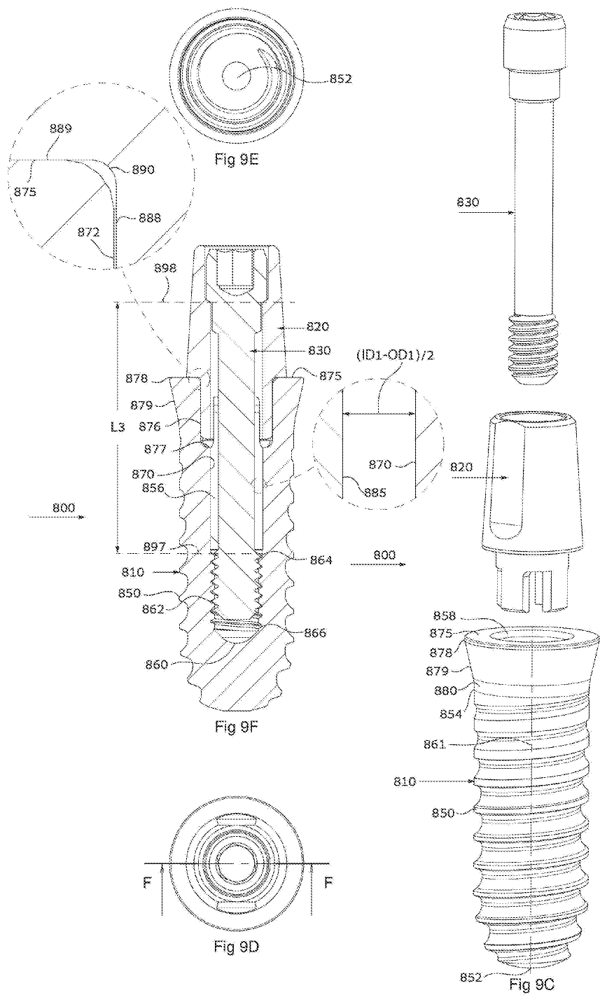

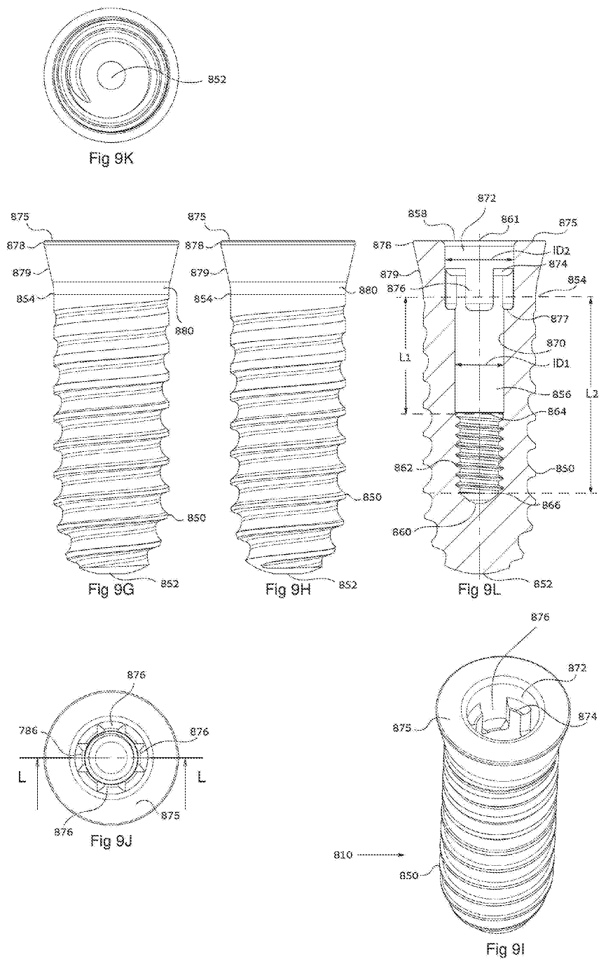

Reference is now made to FIGS. 9A, 9B, 9C, 9D, 9E and 9F, which are simplified illustrations of a dental implant constructed and operative in accordance with still another preferred embodiment of the present invention, and to FIGS. 9G, 9H, 9I, 9J, 9K and 9L, which are simplified illustrations of a base body, forming part of the dental implant of FIGS. 9A-9F.

As seen in FIGS. 9A-9F, there is provided a dental implant 800 constructed and operative in accordance with a preferred embodiment of the present invention. The dental implant 800 preferably comprises a base body 810, preferably formed of a ceramic material, such as zirconia, and an implant superstructure, here an abutment 820, preferably formed of metal, such as titanium, or alternatively a ceramic or a polymer. The abutment 820 is secured to the base body 810 by a screw 830, preferably formed of metal, typically titanium, or alternatively a ceramic or a polymer.

In accordance with a preferred embodiment of the invention, and as shown in FIGS. 9G-9L, base body 810 is formed as a single ceramic piece having an outer surface and is anchorable in a jawbone. The outer surface of base body 810 is preferably formed with an externally threaded portion 850 extending from an apex 852 of the base body 810 nearly up to a bone line 854, which is the line at which the base body 810 is intended to protrude from the jawbone.

In accordance with a preferred embodiment of the present invention, base body 810 is formed with an axial hole 856 extending from an opening 858 of the axial hole 856 to a closed end 860 of the axial hole 856 about an axis 861, which is also the axis of symmetry of base body 810. The axial hole 856 is formed with internally threaded portion 862, located adjacent end 860. The internally threaded portion 862 preferably extends from a first location 864 in the axial hole 856 furthest from the end 860 to a second location 866 in the axial hole 856 closest to the end 860.

A first length L1 is defined as the axially extending length of axial hole 856 from the first location 864 to the bone line 854. A second length L2 is defined as the axially extending length of axial hole 856 from the second location 866 to the bone line 854.

Axial hole 856 defines a first inner facing base body surface 870, having a first inner diameter ID1, along at least part of the first length L1, and a second inner facing base body surface 872, having a second inner diameter ID2 and extending upwardly from the first inner facing base body surface 870 and defining therewith a shoulder 874.

Base body 810 defines a bearing surface 875, which is preferably a flat annular surface which surrounds opening 858 of axial hole 856, at second inner facing base body surface 872 having second inner diameter ID2. Formed in first inner facing base body surface 870 of base body 810 are typically four evenly azimuthally distributed axially directed recesses 876, which are radially spaced from and extend parallel to axis 861 and removably accommodate an installation tool (not shown) and abutment 820. Recesses 876 extend downwardly to a location 877 typically just below the bone line 854.

As seen particularly in the illustrated embodiment of FIG. 9L, axial hole 856 is preferably formed with a generally circular cross section along first length L1 and first inner diameter ID1 is a diameter thereof. Alternatively, axial hole 856 may be formed with any suitable cross sectional configuration, such as rectangular or hexagonal, and first inner diameter ID1 is defined as the diameter of the largest circle circumscribed thereby. In another alternative embodiment, internally threaded portion 862 of axial hole 856 may extend upwardly to location 877 and first inner diameter ID1 is defined as the inner diameter of internally threaded portion 862 of axial hole 856.

Preferably, the outer surface of base body 810 includes a curved top portion 878 adjacent bearing surface 875. Below curved top portion 878 is a main inwardly downwardly tapered portion 879, which terminates in an intermediate portion 880, which preferably is a circular cylindrical portion, which terminates at the bone line 854.

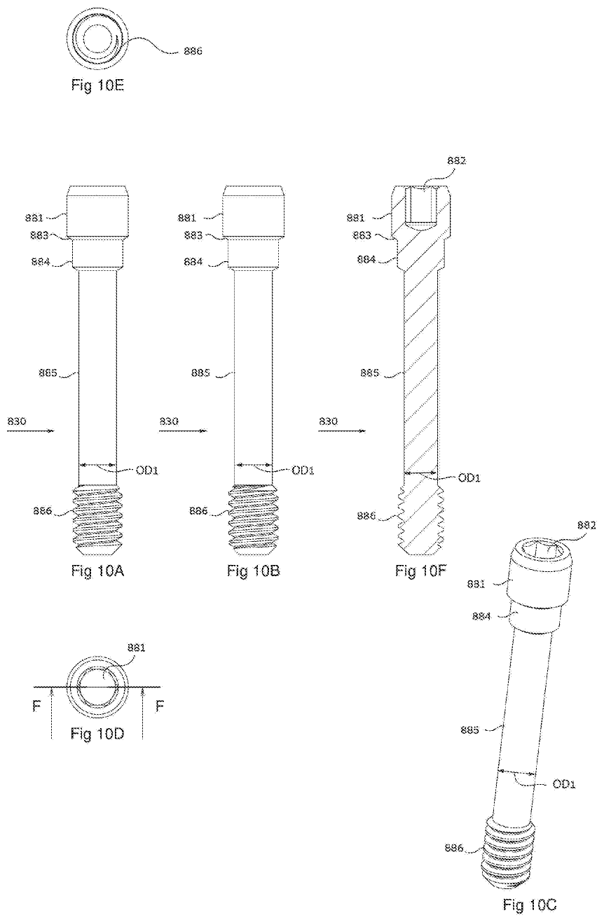

Reference is now made to FIGS. 10A, 10B, 10C, 10D, 10E and 10F, which are simplified respective first and second side view, perspective view, top and bottom view and sectional illustrations of a preferred embodiment of screw 830, forming part of the dental implant of FIGS. 9A-9F, FIG. 10F being taken along lines F-F in FIG. 10D.

As seen in FIGS. 10A-10F, screw 830 is an elongate, generally circularly symmetric element configured to threadably engage axial hole 856 in base body 810. Screw 830 comprises a head portion 881 having an internal socket 882. Extending below head portion 881 and defining a shoulder 883 therewith, is an intermediate portion 884 and below intermediate portion 884 is at least one shank portion, preferably a single smooth shank portion 885, which terminates in a threaded portion 886. The smooth shank portion 885 has a first outer diameter OD1, which is configured to be substantially less than the first inner diameter ID1 of axial hole 856. Typically OD1 is 1.35 mm and ID1 is 1.95 mm.

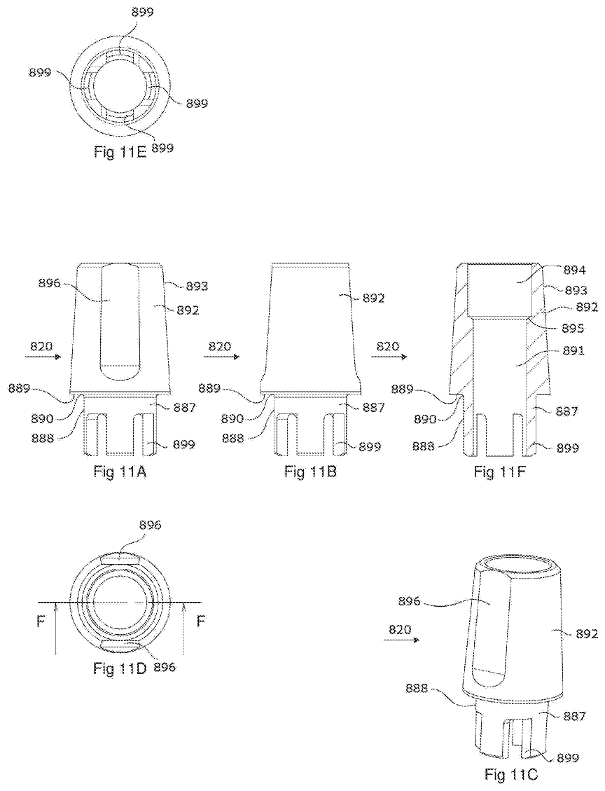

Reference is now made to FIGS. 11A, 11B, 11C, 11D, 11E and 11F, which are simplified respective first and second side view, perspective view, top and bottom view and sectional illustrations of abutment 820, forming part of the dental implant of FIGS. 9A-9F, FIG. 11F being taken along lines F-F in FIG. 11D. Abutment 820 forms all or part of an implant superstructure.

As seen in FIGS. 11A-11F, abutment 820 comprises a generally cylindrical base portion 887 having typically four evenly azimuthally distributed axially directed teeth 899 configured to securely seat in corresponding evenly azimuthally distributed axially directed recesses 876 of base body 810. Generally cylindrical base portion 887 is preferably formed with a generally cylindrical outer surface 888 which terminates upwardly at an annular downward-facing engagement surface 889 at a curved circular junction 890. Generally cylindrical base portion 887 is preferably formed with a cylindrical axial bore 891.

Extending upwardly from engagement surface 889 is a hollow, generally conical portion 892, having a conical outer surface 893 and a cylindrical axial bore 894, which defines a shoulder 895 with cylindrical axial bore 891. Conical outer surface 893 is preferably formed with a pair of oppositely-facing elongate recesses 896.

Returning now to FIGS. 9A, 9B, 9C, 9D, 9E and 9F, it is seen that when the dental implant 800 is an assembled state, following anchoring of the base body 810 in a jawbone, threaded portion of screw 830 is fully threaded into corresponding threaded portion 862 of base body 810.

It is a particular feature of the illustrated embodiment of the present invention that, as seen particularly in the enlargement of FIG. 9F, generally cylindrical outer surface 888 of abutment 820 is spaced from second inner facing base body surface 872 of base body 810 adjacent curved circular junction 890, typically by a radial separation of 0.01 mm, while engagement surface 889 is in tight engagement with bearing surface 875.

It is a further particular feature of the illustrated embodiment of the present invention, that, as seen particularly in FIG. 9F, the smooth shank portion 885 of screw 830, which extends along the length of axial hole 856, is spaced from the inner-facing base body surface 870 of the base body 810, preferably by an radial separation, (ID1−OD1)/2, of approximately 0.3 mm.

It is a further particular feature of the illustrated embodiment of the present invention, as seen particularly in FIG. 9F, that an axial distance, which is a relatively large axial distance compared to existing non-metal dental implants, defined as L3, from a highest location 897 of mutually engaged threadings of the screw 830 and the base body 810 and a location 898 at which shoulder 883 of screw 830 engages shoulder 895 of abutment 820, is defined in the assembled implant.

It is appreciated that the present invention is characterized by limited bendability of screw 830, thereby reducing stress applied to mutually engaged threaded portions of screw 830 and base body 810 during use.

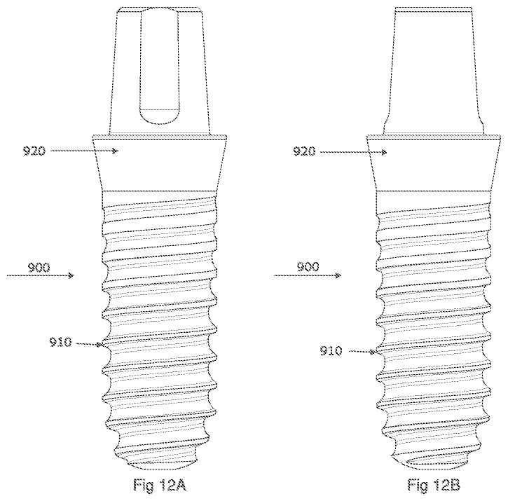

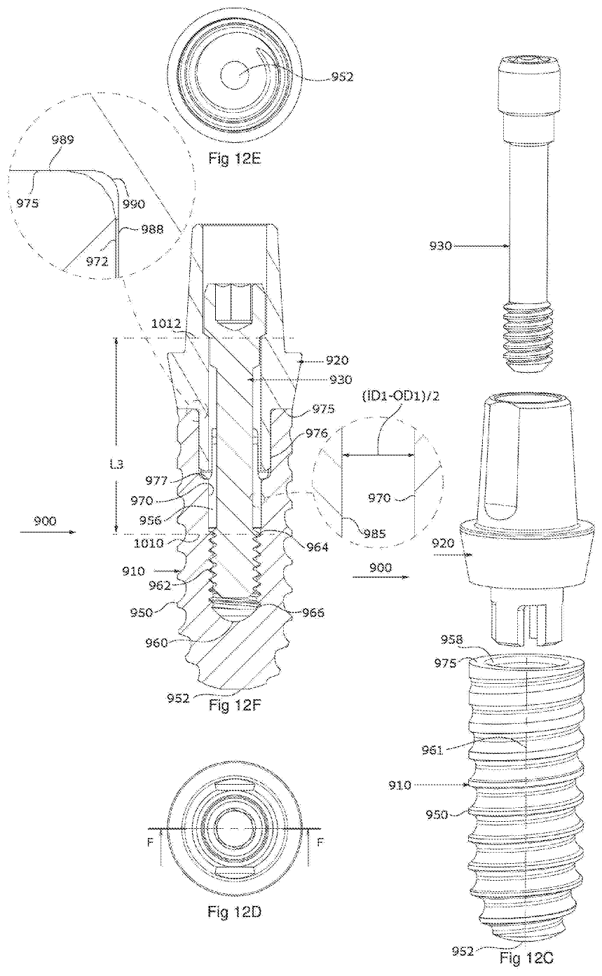

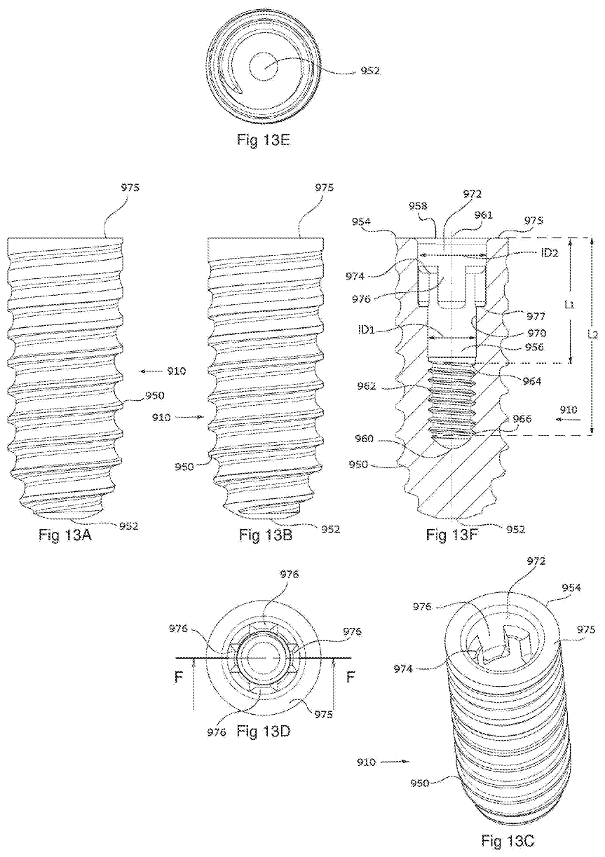

Reference is now made to FIGS. 12A, 12B, 12C, 12D, 12E and 12F, which are simplified illustrations of a dental implant constructed and operative in accordance with still another preferred embodiment of the present invention, and to FIGS. 13A, 13B, 13C, 13D, 13E and 13F, which are simplified illustrations of a base body, forming part of the dental implant of FIGS. 12A-12F.

As seen in FIGS. 12A-12F, there is provided a dental implant 900 constructed and operative in accordance with a preferred embodiment of the present invention. The dental implant 900 preferably comprises a base body 910, preferably formed of a ceramic material, such as zirconia, or alternatively formed of a polymer, such as polyether ether ketone (PEEK), which may be reinforced, or as a further alternative formed of a composite material, and an implant superstructure, here an abutment 920, preferably formed of a ceramic material, such as zirconia, or alternatively a metal, such as titanium, or a polymer. The abutment 920 is secured to the base body 910 by a screw 930, preferably formed of metal, typically titanium, or alternatively a ceramic or a polymer.

In accordance with a preferred embodiment of the invention and as shown in FIGS. 13A-13F, base body 910 is formed as a single ceramic piece having an outer surface and is anchorable in a jawbone. The outer surface of base body 910 is preferably formed with an externally threaded portion 950 extending from an apex 952 of the base body 910 nearly up to a bone line 954, which is the line at which the top of the base body is generally coplanar with a top surface of the jawbone.

In accordance with a preferred embodiment of the present invention, base body 910 is formed with an axial hole 956 extending from an opening 958 of the axial hole 956 to a closed end 960 of the axial hole 956 about an axis 961, which is also the axis of symmetry of base body 910. The axial hole 956 is formed with internally threaded portion 962, located adjacent end 960. The internally threaded portion 962 preferably extends from a first location 964 in the axial hole 956 furthest from the end 960 to a second location 966 in the axial hole 956 closest to the end 960.

A first length L1 is defined as the axially extending length of axial hole 956 from the first location 964 to the bone line 954. A second length L2 is defined as the axially extending length of axial hole 956 from the second location 966 to the bone line 954.

Axial hole 956 defines a first inner facing base body surface 970, having a first inner diameter ID1, along at least part of the first length L1, and a second inner facing base body surface 972, having a second inner diameter ID2 and extending upwardly from the first inner facing base body surface 970 and defining therewith a shoulder 974.

Base body 910 defines a bearing surface 975, which is preferably a flat annular surface which surrounds opening 958 of axial hole 956, at bone line 954. Formed in first inner facing base body surface 970 of base body 910 are typically four evenly azimuthally distributed axially directed recesses 976, which are radially spaced from and extend parallel to axis 961 and removably accommodate an installation tool (not shown) and abutment 920. Recesses 976 extend downwardly to a location 977 well below the bone line 954.

As seen particularly in the illustrated embodiment of FIG. 13F, axial hole 956 is preferably formed with a generally circular cross section along first length L1 and first inner diameter ID1 is a diameter thereof. Alternatively, axial hole 956 may be formed with any suitable cross sectional configuration, such as rectangular or hexagonal, and first inner diameter ID1 is defined as the diameter of the largest circle circumscribed thereby. In another alternative embodiment, internally threaded portion 962 of axial hole 956 may extend upwardly to location 977 and first inner diameter ID1 is defined as the inner diameter of internally threaded portion 962 of axial hole 956.

Preferably, the outer surface of base body 910 terminates at the bone line 954.

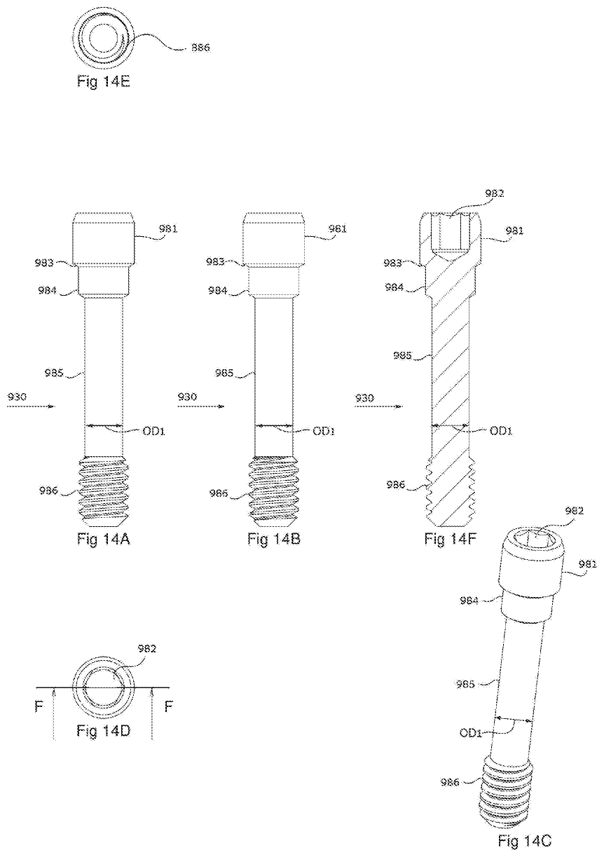

Reference is now made to FIGS. 14A, 14B, 14C, 14D, 14E and 14F, which are simplified respective first and second side view, perspective view, top and bottom view and sectional illustrations of a preferred embodiment of screw 930, forming part of the dental implant of FIGS. 12A-12F, FIG. 14F being taken along lines F-F in FIG. 14D.

As seen in FIGS. 14A-14F, screw 930 is an elongate, generally circularly symmetric element configured to threadably engage axial hole 956 in base body 910. Screw 930 comprises a head portion 981 having an internal socket 982. Extending below head portion 981 and defining a shoulder 983 therewith, is an intermediate portion 984 and below intermediate portion 984 is at least one shank portion, preferably a single smooth shank portion 985, which terminates in a threaded portion 986. The smooth shank portion 985 has a first outer diameter OD1, which is configured to be substantially less than the first inner diameter ID1 of axial hole 956. Typically OD1 is 1.35 mm and ID1 is 1.95 mm.

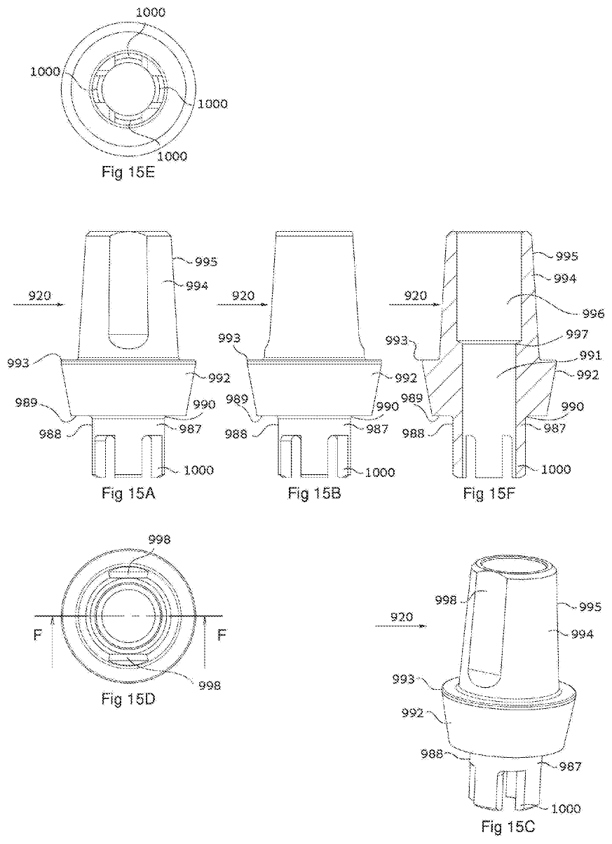

Reference is now made to FIGS. 15A, 15B, 15C, 15D, 15E and 15F, which are simplified respective first and second side view, perspective view, top and bottom view and sectional illustrations of abutment 920, forming part of the dental implant of FIGS. 12A-12F, FIG. 15F being taken along lines F-F in FIG. 15D. Abutment 920 forms all or part of an implant superstructure.

As seen in FIGS. 15A-15F, abutment 920 comprises a generally cylindrical base portion 987 having typically four evenly azimuthally distributed axially directed teeth 1000 configured to securely seat in corresponding evenly azimuthally distributed axially directed recesses 976 of base body 910. Generally cylindrical base portion 987 is preferably formed with a generally cylindrical outer surface 988 which terminates upwardly at an annular downward-facing engagement surface 989 at a curved circular junction 990. Generally cylindrical base portion 987 is preferably formed with a cylindrical axial bore 991.

Extending upwardly from engagement surface 989 is a curved tapered portion 992 which terminates in an upwardly inwardly curved cylindrical portion 993. Above cylindrical portion 993 is a hollow, generally conical portion 994, having a conical outer surface 995 and a cylindrical axial bore 996, which defines a shoulder 997 with cylindrical axial bore 991. Conical outer surface 995 is preferably formed with a pair of oppositely-facing elongate recesses 998.

Returning now to FIGS. 12A, 12B, 12C, 12D, 12E and 12F, it is seen that when the dental implant 900 is an assembled state, following anchoring of the base body 910 in a jawbone, threaded portion of screw 930 is fully threaded into corresponding threaded portion 962 of base body 910.

It is a particular feature of the illustrated embodiments of the present invention that, as seen particularly in the enlargement of FIG. 12F, generally cylindrical outer surface 988 of abutment 920 is spaced from second inner facing base body surface 972 of base body 910 adjacent curved circular junction 990, typically by a radial separation of 0.01 mm, while engagement surface 989 is in tight engagement with bearing surface 975.

It is a further particular feature of the illustrated embodiment of the present invention, that, as seen particularly in FIG. 12F, the smooth shank portion 985 of screw 930, which extends along the length of axial hole 956, is spaced from the inner-facing base body surface 970 of the base body 910, preferably by an radial separation, (ID1−OD1)/2, of approximately 0.3 mm.

It is a further particular feature of the illustrated embodiment of the present invention as seen particularly in FIG. 9F that an axial distance, which is a relatively large axial distance compared to existing non-metal dental implants, defined as L3, from a highest location 1010 of mutually engaged threadings of the screw 930 and the base body 910 and a location 1012 at which shoulder 983 of screw 930 engages shoulder 997 of abutment 920, is defined in the assembled implant.

It is appreciated that the present invention is characterized by limited bendability of screw 930, thereby reducing stress applied to mutually engaged threaded portions of screw 930 and base body 910 during use.

It is appreciated that the typical radial separations between the smooth shank portions of the screws and the inner facing base body surfaces of the base bodies, when in an assembled state, defined in the embodiments hereinabove are illustrative and the actual radial separation between the smooth shank portion of the screw and the inner facing base body surface of the base body when in an assembled state is preferably in the range of 0.01 mm to 0.6 mm and more preferably, in the range of 0.05 to 0.3 mm.

It is appreciated that the first length L1 defined in the embodiments described hereinabove is preferably in the range of 0.8 mm to 5.8 mm, more preferably in the range of 2.3 mm to 5.3 mm and even more preferably in the range of 3.8 mm to 4.8 mm. A most preferred value for first length L1 is 4.25 mm.

It is appreciated that the second length L2 defined in the embodiments described hereinabove is preferably in the range of 0.8 mm to 7.8 mm, more preferably in the range of 3.0 mm to 7.5 mm and even more preferably in the range of 5.2 mm to 7.2 mm. A most preferred value for second length L2 is 7 mm.

It is appreciated that the relatively large axial distance L3 defined in the embodiments described hereinabove is preferably equal to or greater than 5.1 mm, more preferably equal to or greater than 5.3 mm, even more preferably equal to or greater than 5.5 mm and still more preferably equal to or greater than 6.0 mm. A most preferred value for the relatively large axial distance L3 is equal to or greater than 6.9 mm.

It will be appreciated by persons skilled in the art that the present invention is not limited to what has been particularly shown and described hereinabove. Rather the scope of the invention includes both combinations and sub-combinations of various features described herein as well as modifications thereof which are not in the prior art.

1. A dental implant comprising:
a base body, formed as a single ceramic piece or formed of a polymer or a composite material,
said base body having an outer surface, anchorable in a jawbone,
said base body defining a bone line, which is configured to be located adjacent a top of said jawbone,
said base body having an apex, which is configured to be inserted within said jawbone,
said base body having formed therein an axial hole extending from an opening of said axial hole to an end of said axial hole,
said axial hole having an internally threaded portion located adjacent said end of said axial hole, said internally threaded portion extending from a first location in said axial hole, furthest from said end of said axial hole, to a second location in said axial hole, closest to said end,
said axial hole defining a first length L1 extending from said first location to said bone line,
said axial hole defining a first inner facing base body surface having a first inner diameter ID1 along at least part of said first length L1,
said base body having formed thereon an externally threaded portion,
said base body defining a bearing surface;
an implant superstructure configured to be attached to said base body and to contact said bearing surface of said base body and including a shoulder, and
a screw configured for attaching said implant superstructure to said base body,
said screw comprising a head portion and a shank portion, said shank portion including at least one smooth shank portion and a threaded portion, said screw defining a shoulder between said head portion and said shank portion,
said at least one smooth shank portion being configured to have a first outer diameter OD1, which is substantially less than said first inner diameter ID1 of said axial hole,
whereby in an assembled state of said dental implant:
said at least one smooth shank portion is spaced from said first inner facing base body surface; and
said dental implant defines a distance L3, between a location furthest from said apex at which said threaded portion of said screw threadably engages said internally threaded portion of said axial hole and a location at which said shoulder of said screw engages said shoulder of said implant superstructure, which is substantially greater than said first length L1.

2. A dental implant according to claim 1 and wherein said base body is formed as a single ceramic piece.

3. A dental implant according to claim 1 and wherein said base body is formed of a polymer.

4. A dental implant according to claim 3 and wherein said polymer is polyether ether ketone (PEEK).

5. A dental implant according to claim 3 and wherein said polymer is reinforced.

6. A dental implant according to claim 1 and wherein said base body is formed of a composite material.

7. A dental implant according to claim 1 and wherein said distance L3 is equal to or greater than 5.1 mm.

8. A dental implant according to claim 7 and characterized by limited bendability of said screw, thereby reducing stress applied to mutually engaged threaded portions of said screw and said base body during use.

9. A dental implant according to claim 1 and wherein said distance L3 is equal to or greater than 5.3 mm.

10. A dental implant according to claim 9 and characterized by limited bendability of said screw, thereby reducing stress applied to mutually engaged threaded portions of said screw and said base body during use.

11. A dental implant according to claim 1 and wherein said distance L3 is equal to or greater than 5.5 mm.

12. A dental implant according to claim 11 and characterized by limited bendability of said screw, thereby reducing stress applied to mutually engaged threaded portions of said screw and said base body during use.

13. A dental implant according to claim 1 and wherein said distance L3 is equal to or greater than 6.0 mm.

14. A dental implant according to claim 13 and characterized by limited bendability of said screw, thereby reducing stress applied to mutually engaged threaded portions of said screw and said base body during use.

15. A dental implant according to claim 1 and wherein said distance L3 is equal to or greater than 6.9 mm.

16. A dental implant according to claim 15 and characterized by limited bendability of said screw, thereby reducing stress applied to mutually engaged threaded portions of said screw and said base body during use.
